(19) United States
(12) Patent Application Publication
(10) Pub. No.: US 2012/0169117 A1
(43) Pub. Date: Jul. 5, 2012

(54) Battery system and electric vehicle including the same

(76) Inventor: Jong-Doo Park, Yongin-si (KR)

(21) Appl. No.: 13/200,936

(22) Filed: Oct. 5, 2011

Related U.S. Application Data
(60) Provisional application No. 61/457,115, filed on Jan. 4, 2011.

(51) Int. Cl. B60L 11/18; H02J 7/00

(52) U.S. Cl. 307/10.7; 320/136

(57) ABSTRACT

A battery system and an electric vehicle including the battery system are disclosed. The battery system may include a battery module having at least two batteries, a bus bar configured to connect the at least two batteries, an integrated circuit (IC) type sensing circuit on the bus bar, the IC type sensing circuit being configured to sense a temperature of the bus bar, a battery management system configured to control operation of the battery module, and a communication device configured to supply data output from the IC type sensing circuit to the battery management system.

### CROSS-REFERENCE TO RELATED APPLICATION

This application claims priority to pending U.S. Provisional Application No. 61/457,115, filed in the U.S. Patent and Trademark Office on Jan. 4, 2011, and entitled “BATTERY SYSTEM AND xEV INCLUDING THE SAME,” which is incorporated by reference herein in its entirety and for all purposes.

### BACKGROUND

1. Field

Embodiments relate to a battery system and an electric vehicle including the same.

2. Description of the Related Art

Automobiles with internal-combustion engines, which use gasoline or heavy oil as a main source of fuel, have serious effects in terms of pollution like atmospheric pollution. Thus, to reduce pollution, various attempts are made to develop electric vehicles (xEV), which use electricity.

Electric vehicles use a battery engine that operates using electricity output by a battery. Such electric vehicles include a battery in which a plurality of rechargeable battery cells is included in one pack or module as a source of a main driving force. Thus, no discharge gas is generated at all and only little noise is produced.

The electric vehicles may be classified according to the types of energy sources thereof. For example, the electric vehicles are classified as hybrid electric vehicles (HEV), plug-in hybrid electric vehicles (PHEV), battery electric vehicles (BEV), and fuel cell electric vehicles (FCEV).

For automobiles that use electric energy, the performance of batteries is directly linked to the performance of the vehicles. Thus, not only must the performance of each battery cell be excellent, but also a battery system that efficiently manages charging and discharging of each of the battery cells by measuring a voltage, a current, etc. of the battery is required.

### SUMMARY

One or more embodiments may be directed to a battery system. The battery system may include a battery module having at least two batteries, a bus bar configured to connect the at least two batteries, an integrated circuit (IC) type sensing circuit on the bus bar, the IC type sensing circuit being configured to sense a temperature of the bus bar, a battery management system configured to control operation of the battery module, and a communication device configured to supply data output from the IC type sensing circuit to the battery management system.

The battery system may include a lead frame on the bus bar, the IC type sensing circuit being mounted on the lead frame.

The communication device may include a communication line directly bonded to the lead frame.

The communication device may include a communication line and a connector, the connector connecting the communication line and the IC type sensing circuit.

The bus bar may include a plurality of bus bars, each bus bar being configured to connect at least two batteries of the battery module.

At least two of the plurality of bus bars may include a corresponding IC type sensing circuit thereon.

Each bus bar may have a corresponding IC type sensing circuit thereon, such that the battery system includes a plurality of IC type sensing circuits.

The communication device may include a corresponding plurality of communication lines configured to supply data from the plurality of IC type sensing circuits to outside the battery module.

The communication device may include a corresponding plurality of connectors connecting the plurality of IC type sensing circuits to a corresponding communication line.

The communication device may include external communication lines configured to supply data from IC type sensing circuits to outside the battery module, the communication device may have fewer external communication lines than the plurality of IC type sensing circuits, the communication device may include internal communication lines configured to supply data between IC type sensing circuits, and the internal communication lines may be configured to supply data from IC type sensing circuits not having an external communication line to IC type sensing circuits having an external communication line.

The communication device includes a single external communication line.

The internal communication lines may be arranged in a zigzag pattern.

The external and internal communication lines may be directly bonded to the IC type sensing circuit.

The communication device may include connectors, the connectors connecting the communication line and the IC type sensing circuit.

The communication device may include a communication line between the IC type sensing circuit and the battery management system.

The communication device may include a first connector, the first connector being configured to connect the communication line and the IC type sensing circuit and a second connector, the second connector being configured to connect the communication line and the battery management system.

The first connector and the second connector may have the same form.

The communication line may be directly bonded to the IC type sensing circuit and the battery management system.

The IC type sensing circuit may be directly attached to the bus bar.

One or more embodiments may be directed to an electric vehicle including a battery system in accordance with embodiments, a motor generator, and an inverter between the battery system and the motor generator, the inverter being electrically coupled to the battery system and the motor generator.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates a block diagram of a battery system and peripheral devices of the battery system, according to an embodiment;

FIG. 2 illustrates a state of coupling of the battery system of FIG. 1;

FIG. 3 illustrates a block diagram of a battery system and peripheral devices of the battery system, according to another embodiment;

FIG. 4 illustrates a state of coupling of the battery system of FIG. 3;

FIG. 5 illustrates a block diagram of a battery system and peripheral devices of the battery system, according to another embodiment;

FIG. 6 illustrates a state of coupling of the battery system of FIG. 5;

FIG. 7 illustrates a block diagram illustrating a battery system and peripheral devices of the battery system, according to another embodiment;

FIG. 8 illustrates a state of coupling of the battery system of FIG. 7; and

FIG. 9 illustrates is perspective schematic view of an electric vehicle including a battery system according to embodiments.

### DETAILED DESCRIPTION

Reference will now be made in detail to embodiments, examples of which are illustrated in the accompanying drawings, wherein like reference numerals refer to like elements throughout.

As embodiments allow for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the embodiments are encompassed. In the description, certain detailed explanations of related art are omitted when it is deemed that they may unnecessarily obscure the essence of embodiments.

Embodiments will be described below in more detail with reference to the accompanying drawings. Those components that are the same or are in correspondence are rendered the same reference numeral regardless of the figure number, and redundant explanations are omitted.

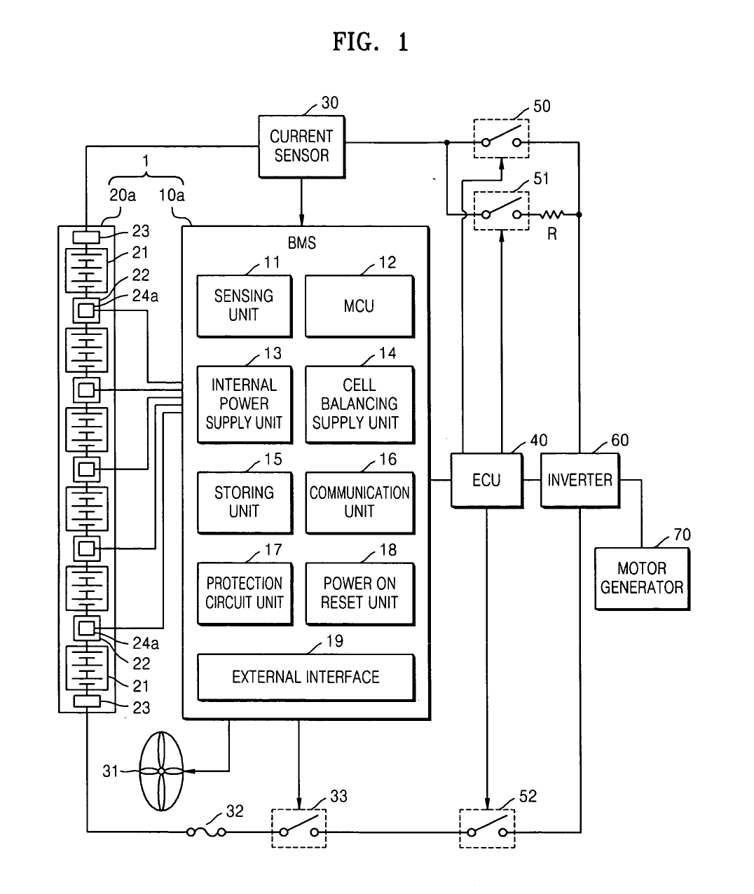

FIG. 1 illustrates a block diagram of a battery system 1 and peripheral devices of the battery system 1, according to an embodiment.

Referring to FIG. 1, an automobile system includes the battery system 1, a current sensor 30, a cooling fan 31, a fuse 32, a main switch 33, an electronic control unit (ECU) 40, a first main relay 50, an auxiliary relay 51, a second main relay 52, an inverter 60, and a motor generator 70.

The battery system 1 may supply electric power to a motor, and store power generated and supplied from the outside. The battery system 1 may include a battery management system 10a and a battery 20a.

First, the battery 20a will be described. The battery 20a may include a plurality of battery modules 21 in which a plurality of battery cells are serially connected. The battery cells included in each of the battery modules 21 are rechargeable secondary batteries. In the current embodiment, six battery modules 21 are included, but the embodiment is not limited thereto. Also, a safety switch (not shown) may be disposed at least between one pair of battery modules 21. The safety switch is disposed between the plurality of battery modules 21 and is turned on or off manually for safety of an operator when changing the battery modules 21 or performing operations with respect to the battery 20a.

The battery 20a may include a plurality of bus bars 22 electrically connecting positive electrodes and negative electrodes of the plurality of battery modules 21 in series or in parallel. The serial or parallel connection of the plurality of battery modules 21 may be determined according to a method of coupling the bus bars 22. Also, the battery 20a may include a bus bar 23 for outputting electric power to the outside. The bus bar 23 is electrically connected to the inverter 60 and outputs electric power stored in the battery 20a to the inverter 60.

Meanwhile, if the bus bars 22 and 23, which electrically connect the plurality of battery modules 21, are not properly/precisely coupled, resistance between the bus bars 22 and 23 and the battery modules 21 increases. Consequently, more heat than usual is generated in the bus bars 22 and 23.

In order to reduce or eliminate an increase in resistance, a sensing circuit 24a may be formed on each of the plurality of bus bars 22. The sensing circuit 24a may be an integrated circuit (IC) with which a voltage and/or a temperature of the bus bars 22 may be measured. The sensing circuit 24a may transmit data regarding the measured voltage and/or the measured temperature to the BMS 10a via data communication. Accordingly, the sensing circuit 24a and the BMS 10a may be connected to each other via a communication line. For example, the sensing circuit 24a and the BMS 10a may be connected to each other via a communication line in a direct bonding method.

Communication between the sensing circuit 24a and the BMS 10a may be performed, e.g., using an inter-integrated circuit (I2C) method, a low-voltage differential signaling (LVDS) method, or a reduced swing differential signaling (RSDS) method. For example, the communication method may be determined according to an amount of data transmission or transmission speed required for communication between the sensing circuit 24a and the BMS 10a, from among various communication methods. For example, if the amount of data transmission is relatively small, the sensing circuit 24a and the BMS 10a may be designed to use the I2C method. If the amount of data transmission is relatively large, the sensing circuit 24a and the BMS 10a may be designed to use the LVDS method.

The BMS 10a controls charging and discharging of the battery 20a to facilitate stable operation of the battery 20a. The BMS 10a may include a sensing unit 11, a micro control unit (MCU) 12, an internal power supply unit 13, a cell balancing unit 14, a storing unit 15, a communication unit 16, a protection circuit unit 17, a power on reset unit 18, and an external interface 19.

The sensing unit 11 measures a total current of the battery 20a (hereinafter, a battery current), a total voltage of the battery 20a (hereinafter, a battery voltage), a temperature of the battery 20a, and an ambient temperature around the battery cells, and transmits these measurements to the MCU 12. Also, the sensing unit 11 may measure a voltage of the inverter 60 and transmit the measured voltage to the MCU 12.

The MCU 12 may calculate a state of charging (SOC) of the battery 20a based on the battery current, the battery voltage, each battery cell voltage, the battery temperature, and the ambient temperature around the battery cells transmitted by the sensing unit 11. Also, the MCU 12 calculates variation in internal resistance of the battery 20a to calculate a state of aging or a state of health (SOH) of the battery 20a. The MCU 12 generates information notifying of the states of the battery 20a based on results of the calculation.

The internal power supply unit 13 is a device that usually supplies power to the BMS 10a using an auxiliary battery.

The cell balancing unit 14 balances a SOC of each cell or each battery module 21. For example, the cell balancing unit 14 may discharge a cell or one of the battery modules 21 having a relatively high SOC and charge a cell or one of the battery modules 21 having a relatively low SOC.

The storing unit 15 stores data, e.g., a current SOC, a current SOH, etc., when the BMS 10a is turned off. The storing unit 15 may be a non-volatile storage medium to and from which data may be electrically written or removed, e.g., an electrically erasable programmable read only memory (EEPROM).

The communication unit 16 receives information related to a voltage and/or a temperature transmitted from the plurality of sensing circuits 24a. The communication unit 16 may communicate with the ECU 40 of an automobile. The communication unit 16 may transmit information about a SOC or a SOH from the BMS 10a to the ECU 40 and/or may receive information about a state of the automobile from the ECU 40 and transmit the received information to the MCU 12.

According to the current embodiment, the plurality of sensing circuits 24a respectively include a communication line so as to be connected to the communication unit 16, and the communication unit 16 may perform data communication with each of the sensing circuits 24a.

The protection circuit unit 17 is a circuit for protecting the battery 20a in the event of an external impact, an overcurrent, a low voltage, or the like, using firmware.

The power on reset unit 18 resets the entire battery system 1 when the BMS 10a is turned on.

The external interface 19 is used to connect peripheral devices of the BMS 10a, e.g., the cooling fan 31, the main switch 33, etc., to the MCU 12. In the current embodiment, only the cooling fan 31 and the main switch 33 are illustrated for simplicity.

Also, although not shown in FIG. 1, the BMS 10a may determine whether the relays 50 through 52 are out of order or welded.

The current sensor 30 measures an amount of output current of the battery 20a and outputs the same to the sensing unit 11 of the BMS 10a. The current sensor 30 may be a Hall current transformer (Hall CT) that measures a current using a Hall element and outputs an analog current signal corresponding to the measured current. However, the current sensor 30 is not limited thereto.

The cooling fan 31 dissipates heat that may be created by charging/discharging of the battery 20a based on a control signal of the BMS 10a to thereby prevent deterioration of the battery 20a or decrease in efficiency of charging/discharging of the battery 20a due to a temperature increase.

The fuse 32 prevents an overcurrent due to a short circuit from being applied to the battery 20a by disconnecting/breaking. For example, if an overcurrent is generated, the fuse 32 breaks to prevent an overcurrent from being applied to the battery 20a.

The main switch 33 turns on or off the battery 20a based on a control signal of the BMS 10a or the ECU 40 if an abnormal condition is created such as an overvoltage, an overcurrent, or a high temperature.

The ECU 40 detects a current operating state of the automobile based on information, e.g., a state of an accelerator or a brake of the automobile or a speed of the automobile, and determines necessary torque. In detail, the operating state of the automobile refers to a state KEY ON indicating starting an engine, a state KEY OFF indicating turning off the engine, a state corresponding to a constant-speed drive, or a state corresponding to an acceleration drive. The ECU 40 transmits information about the state of the automobile to the communication unit 16 of the BMS 10a. The ECU 40 controls an output of the motor generator 70 in accordance with torque information. More specifically, the ECU 40 controls switching of the inverter 60 such that the output of the motor generator 70 is in accordance with torque information. Also, the ECU 40 receives information about a SOC of the battery 20a transmitted from the MCU 12 via the communication unit 16 and controls the SOC of the battery 20a to be a target value (e.g., 55%). For example, if the information about the SOC transmitted by the MCU 12 indicates that the SOC is less than 55%, switching of the inverter 60 is controlled to output power toward the battery 20a to charge the battery 20a. Here, a battery current Ib is negative. Meanwhile, if the information about the SOC transmitted by the MCU 12 indicates that the SOC is over 55%, switching of the inverter 60 is controlled to output power toward the motor generator 70 to discharge the battery 20a. Here, the battery current Ib is positive.

The ECU 40 charges or discharges the battery 20a based on the information about the SOC to balance the battery modules 21 as much as possible so as to prevent overcharging or overdischarging of the battery 20a. Thus, the battery 20a may be used efficiently and for a long time. However, since it is difficult to measure an actual SOC of the battery 20a after the battery 20a is mounted in the automobile, the BMS 10a accurately estimates the SOC based on a battery voltage, a battery current, and a cell temperature sensed by the sensing unit 11 and transmits the SOC to the ECU 40.

The first main relay 50, the auxiliary relay 51, and the second main relay 52 control a flow of a charging current or a flow of a discharging current between the battery 20a and the inverter 60 according to the control of the ECU 40. The first main relay 50 is serially connected between a positive electrode of the battery 20a and the inverter 60, and the second main relay 52 is serially connected between a negative electrode of the battery 20a and the inverter 60. The auxiliary relay 51 is serially connected between the positive electrode of the battery 20a and the inverter 60, and at the same time, is connected in parallel to the first main relay 50. The auxiliary relay 51 may further include a resistor R that is serially connected between the inverter 60 and the auxiliary relay 51.

The first main relay 50, the auxiliary relay 51, and the second main relay 52 are turned on or off by the control of the ECU 40. However, the embodiment is not limited thereto, and they may also be controlled by, for example, the BMS 10a. Hereinafter, the operation of the first main relay 50, the auxiliary relay 51, and the second main relay 52 will be described in detail.

The battery 20a supplies a high voltage and a high current to the inverter 60 via the first and second main relays 50 and 52. The auxiliary relay 51 is a pre-charge relay that checks a state of the battery 20a when the battery 20a and the inverter 60 are initially connected and prevents an overcurrent through the inverter 60. The first main relay 50 is turned on when the auxiliary relay 51 is transitioned from an on state to an off state, thereby supplying power stored in the battery 20a to the inverter 60. A capacity of the auxiliary relay 51 is smaller than the first main relay 50, and the auxiliary relay 51 is turned on for a short time when the inverter 60 and the battery 20a are initially connected to each other, and then turned off. The resistor R prevents an overcurrent through the inverter 60 when the auxiliary relay 51 is turned on. The inverter 60 converts power supplied from the battery 20a to an alternating current to operate a motor. Although not shown in FIG. 1, a large capacity electrolyte condenser may be installed at a front end of the inverter 60 in order to planarize fluctuations in voltage of the inverter 60 and stabilize an operation of the inverter 60.

The inverter 60 converts power supplied from the battery 20a to an alternating current based on a control signal of the ECU 40 and supplies the power to the motor generator 70, or converts power generated in the motor generator 70 to a direct current and supplies the power to the battery 20a.

The motor generator 70 operates the automobile by using power stored in the battery 20a based on torque information transmitted by the ECU 40.

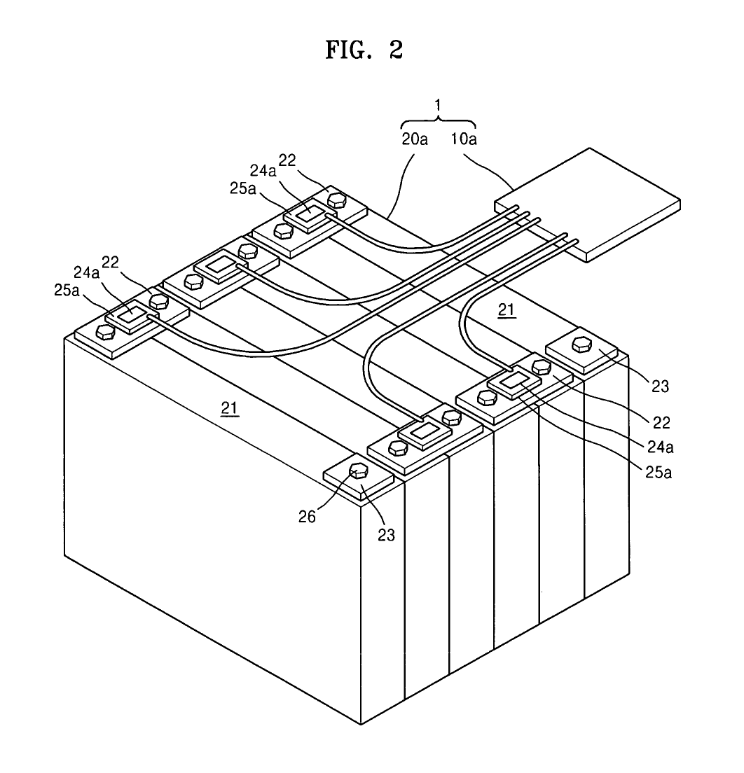

FIG. 2 illustrates a state of coupling of the battery system 1 of FIG. 1.

Referring to FIG. 2, the plurality of battery modules 21 are arranged sequentially. The bus bars 22 electrically connect positive and negative electrodes of adjacent battery modules 21 and also fix the adjacent battery modules 21 by physically coupling the same using screws 26. Also, the bus bars 23, with which power is output to the outside, are installed on the battery modules 21 at two ends of a row of the plurality of battery modules 21.

The sensing circuit 24a is installed on each of the plurality of bus bars 22, which couple the adjacent battery modules 21. The sensing circuit 24a may be directly attached to each of the bus bars 22 or may be installed on a lead frame 25a attached to the bus bars 22. A communication line via which data communication is performed is connected between the lead frame 25a and the BMS 10a using a direct bonding method.

As described above, according to the battery system 1 of the current embodiment, the sensing circuit 24a in the form of an IC and capable of measuring a temperature and/or a voltage of the bus bar 22 is installed on each of the bus bars 22 so as to accurately measure a coupling state of the bus bars 22, and accordingly, the battery 20a may be controlled more stably.

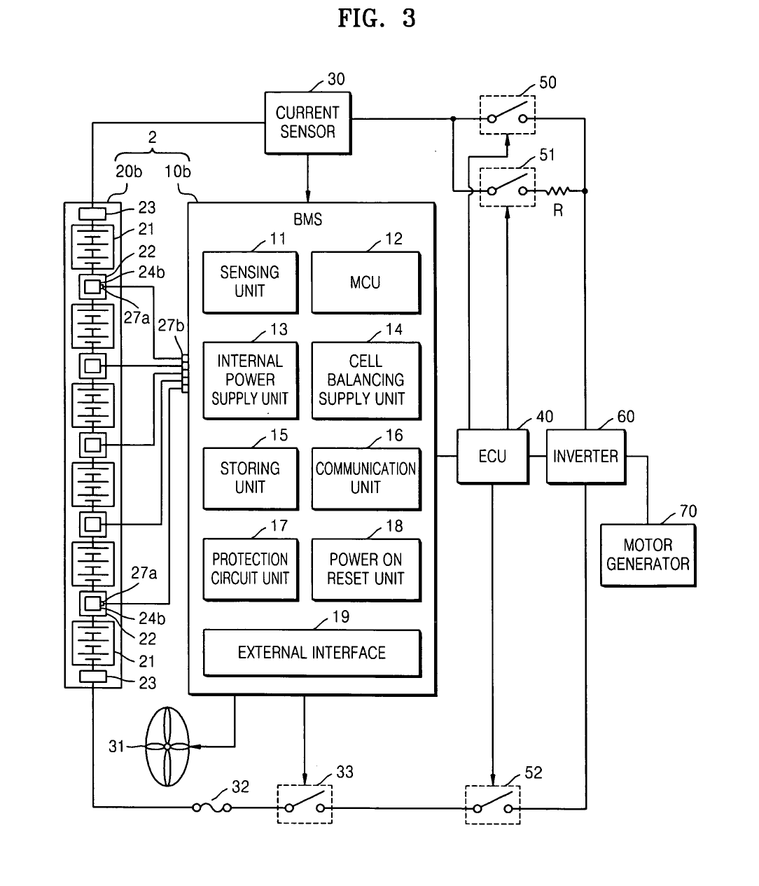

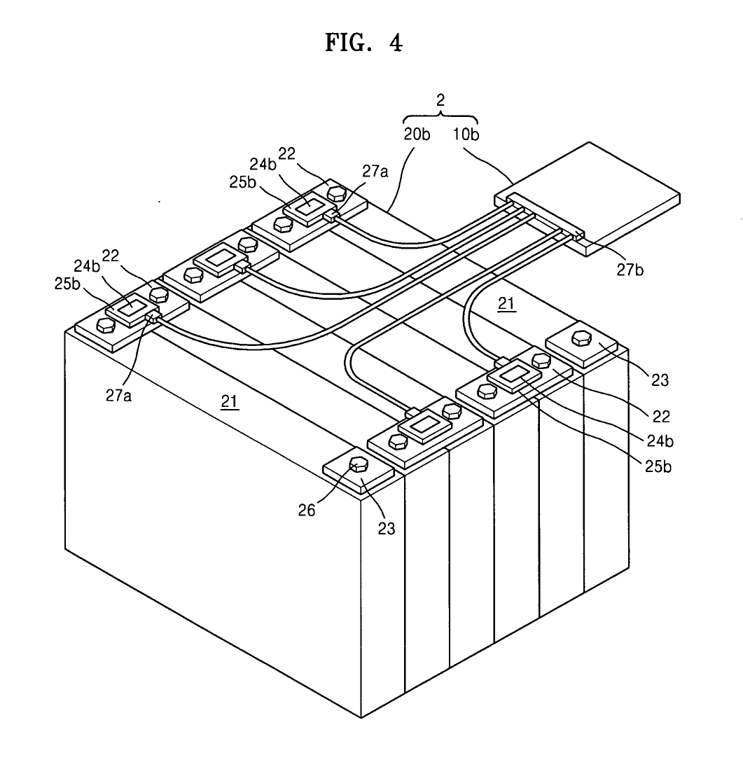

FIG. 3 illustrates a block diagram of a battery system 2 and peripheral devices of the battery system 2, according to another embodiment. FIG. 4 illustrates a state of coupling of the battery system 2 of FIG. 3.

Referring to FIG. 3, the battery system 2 includes a BMS 10b and a battery 20b. Functions of elements of the battery system 2 are substantially the same as those of the battery system 1, and thus descriptions will focus on differences.

According to the current embodiment, a sensing circuit 24b and the BMS 10b are connected via a communication line for transmitting data between the sensing circuit 24b and the BMS 10b, via connectors 27a and 27b. As illustrated in FIGS. 3 and 4, the form of the connector 27a connected to the sensing circuit 24b and the form of the connector 27b connected to the BMS 10b may be different. However, the embodiment is not limited thereto. For example, a communication line including connectors having the same form may be formed at two ends of the communication line, and connectors included on each of a plurality of communication lines extended from each of the plurality of sensing circuits 24b may be separately connected to the BMS 10b.

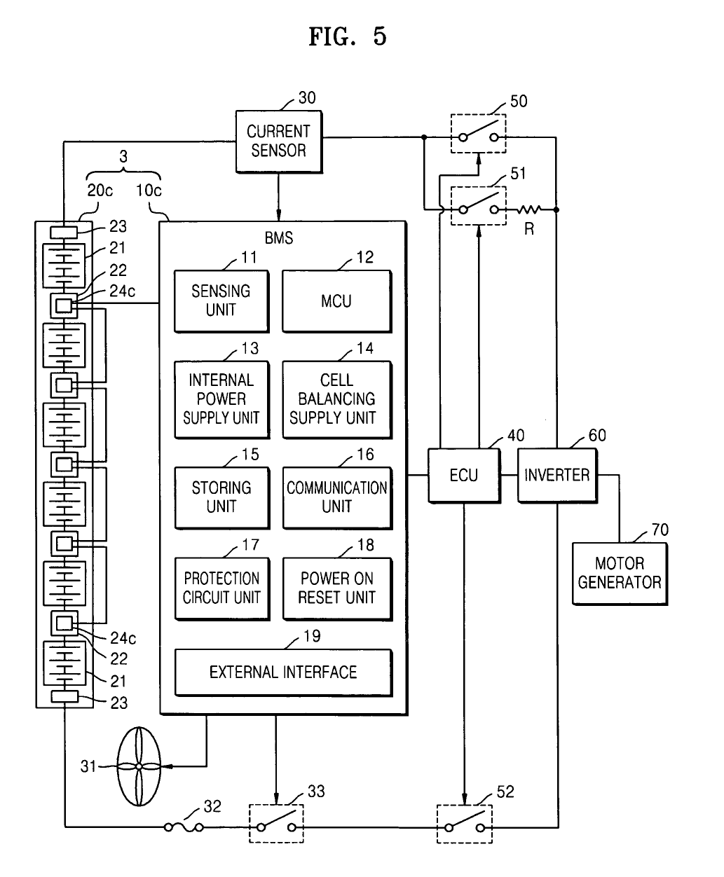

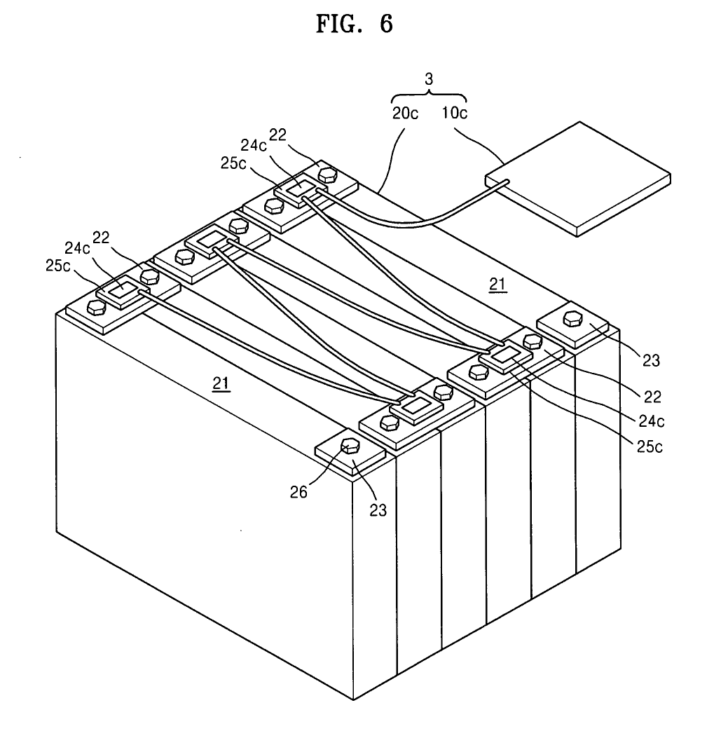

FIG. 5 illustrates a block diagram of a battery system 3 and peripheral devices of the battery system 3, according to another embodiment. FIG. 6 illustrates a state of coupling of the battery system of FIG. 5.

Referring to FIG. 5, the battery system 3 includes a BMS 10c and a battery 20c. Functions of elements of the battery system 3 are substantially the same as those of the battery system 1, and thus descriptions will focus on differences.

According to the current embodiment, a plurality of sensing circuits 24c each transmit measured data on a voltage and/or a temperature of the bus bar 22 to respective adjacent sensing circuits 24c. For example, a sensing circuit at one end transmits measured data to an adjacent sensing circuit, and the sensing circuit that has received the data collects its own data and the received data and transmits the collected data to a next sensing circuit. In this manner, the last sensing circuit, which has received data from all of the other sensing circuits, finally transmits its own data and the received data to the BMS 10c.

In this case, due to the large data amount to be transmitted, the last sensing circuit may use a communication method with a high transmission speed as a method of communication with the BMS 10c. For example, the sensing circuits 24c and the BMS 10c may be designed to use the LVDS method, which has a relatively higher transmission speed than the I2C method, whose transmission speed is relatively slow.

Meanwhile, referring to FIG. 6, the order in which the sensing circuits 24c transmit data is determined according to potentials and communication lines are arranged in a zigzag manner. However, the embodiment is exemplary and is not limited thereto. For example, the data transmission order of the sensing circuits 24c may be determined such that the length of the communication lines is minimized.

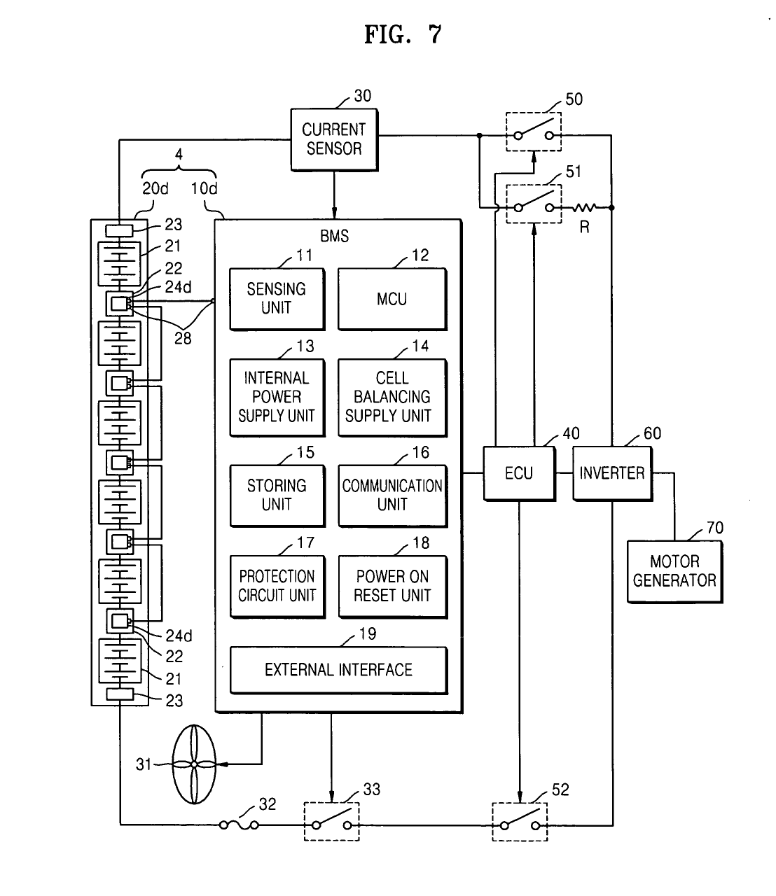

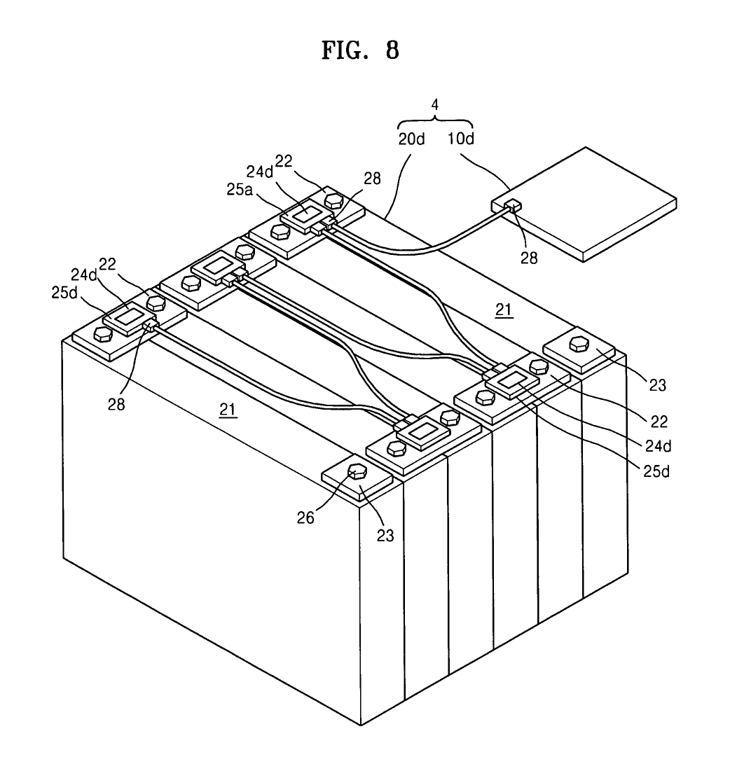

FIG. 7 illustrates a block diagram of a battery system 4 and peripheral devices of the battery system 4, according to another embodiment. FIG. 8 illustrates a state of coupling of the battery system 4 of FIG. 7.

Referring to FIG. 7, the battery system 4 includes a BMS 10d and a battery 20d. Functions of elements of the battery system 4 are substantially the same as those of the battery system 3 of FIG. 5, and thus descriptions will focus on differences.

According to the current embodiment, a communication line for transmitting data between a plurality of sensing circuits 24d connects the sensing circuits 24d via connectors 28. Also, a communication line for transmitting data between the sensing circuits 24d and the BMS 10d also connects the sensing circuit 24d and the BMS 10d via the connectors 28.

As described above, according to the battery systems 1 through 4 of the embodiments, by installing an IC-type sensing circuit on a bus bar, with which a temperature and/or a voltage of the bus bar 22 may be measured, a state of coupling of the bus bar may be accurately measured, and a battery system with which a battery can be controlled more stably and an electrical vehicle including the battery system may be provided.

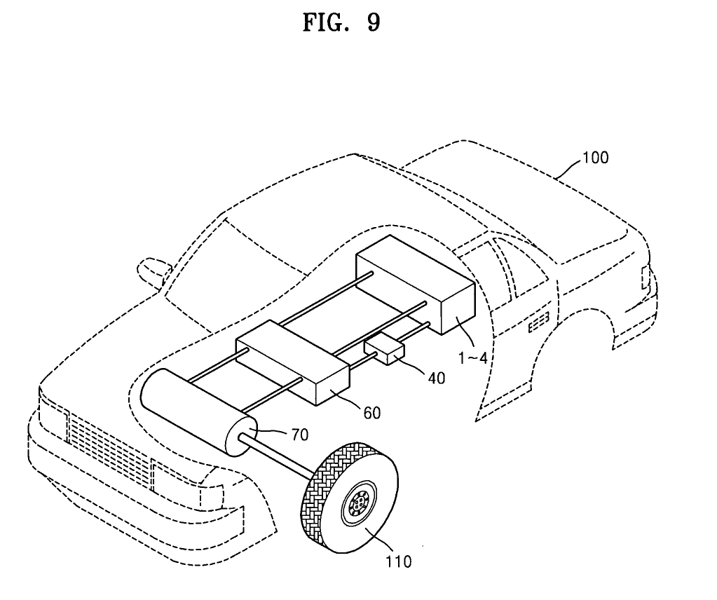

FIG. 9 illustrates is perspective schematic view of an electric vehicle 100 including a battery system according to embodiments. The vehicle 100 may be, e.g., a hybrid electric vehicle, and all-electric vehicle, etc. The vehicle 100 may include a power source that provides a motive power for the vehicle, as well as the battery system 1˜4 described above. The vehicle 100 also includes the ECU 40, the inverter 60, and the motor generator 70. The motor generator 70 is connected to wheels 110 to propel the vehicle 100.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery system, comprising:
a battery module having at least two batteries;
a bus bar configured to connect the at least two batteries;
an integrated circuit (IC) type sensing circuit on the bus bar, the IC type sensing circuit being configured to sense a temperature of the bus bar;
a battery management system configured to control operation of the battery module; and
a communication device configured to supply data output from the IC type sensing circuit to the battery management system.

2. The battery system as claimed in claim 1, further comprising a lead frame on the bus bar, the IC type sensing circuit being mounted on the lead frame.

3. The battery system as claimed in claim 2, wherein the communication device includes a communication line directly bonded to the lead frame.

4. The battery system as claimed in claim 1, wherein the communication device includes a communication line and a connector, the connector connecting the communication line and the IC type sensing circuit.

5. The battery system as claimed in claim 1, wherein the bus bar includes a plurality of bus bars, each bus bar being configured to connect at least two batteries of the battery module.

6. The battery system as claimed in claim 5, wherein at least two of the plurality of bus bars includes a corresponding IC type sensing circuit thereon.

7. The battery system as claimed in claim 6, wherein each bus bar has a corresponding IC type sensing circuit thereon, such that the battery system includes a plurality of IC type sensing circuits.

8. The battery system as claimed in claim 7, wherein the communication device includes a corresponding plurality of communication lines configured to supply data from the plurality of IC type sensing circuits to outside the battery module.

9. The battery system as claimed in claim 8, wherein the communication device includes a corresponding plurality of connectors connecting the plurality of IC type sensing circuits to a corresponding communication line.

10. The battery system as claimed in claim 7, wherein:
the communication device includes external communication lines configured to supply data from IC type sensing circuits to outside the battery module;
the communication device has fewer external communication lines than the plurality of IC type sensing circuits;
the communication device includes internal communication lines configured to supply data between IC type sensing circuits; and
the internal communication lines are configured to supply data from IC type sensing circuits not having an external communication line to IC type sensing circuits having an external communication line.

11. The battery system as claimed in claim 10, wherein the communication device includes a single external communication line.

12. The battery system as claimed in claim 11, wherein the internal communication lines are arranged in a zigzag pattern.

13. The battery system as claimed in claim 12, wherein the external and internal communication lines are directly bonded to the IC type sensing circuit.

14. The battery system as claimed in claim 12, wherein the communication device includes connectors, the connectors connecting the communication line and the IC type sensing circuit.

15. The battery system as claimed in claim 1, wherein the communication device includes a communication line between the IC type sensing circuit and the battery management system.

16. The battery system as claimed in claim 15, wherein the communication device includes:
a first connector, the first connector being configured to connect the communication line and the IC type sensing circuit; and
a second connector, the second connector being configured to connect the communication line and the battery management system.

17. The battery system as claimed in claim 16, wherein the first connector and the second connector have the same form.

18. The battery system as claimed in claim 15, wherein the communication line is directly bonded to the IC type sensing circuit and the battery management system.

19. The battery system as claimed in claim 1, wherein the IC type sensing circuit is directly attached to the bus bar.

20. An electric vehicle, comprising:
a battery system;
a motor generator; and
an inverter between the battery system and the motor generator, the inverter being electrically coupled to the battery system and the motor generator, the battery system including:
a battery module having at least two batteries;
a bus bar configured to connect the at least two batteries;
an integrated circuit (IC) type sensing circuit on the bus bar, the IC type sensing circuit being configured to sense a temperature of the bus bar;
a battery management system configured to control the operation of the battery module; and
a communication device configured to supply data output from the IC type sensing circuit to the battery management system.
